(19) United States
(12) Patent Application Publication
(10) Pub. No.: US 2015/0362343 A1
(43) Pub. Date: Dec. 17, 2015

(54) DEVICE AND METHOD FOR DETERMINING THE POSITION OF A MOVABLE TRANSPORTATION UNIT

(71) Applicant: Airbus Operations GmbH, Hamburg (DE)

(72) Inventor: Ralph Knueppel, Hamburg (DE)

(73) Assignee: Airbus Operations GmbH, Hamburg (DE)

(21) Appl. No.: 14/735,315

(22) Filed: Jun. 10, 2015

(30) Foreign Application Priority Data
Jun. 12, 2014 (DE) 10 2014 108 299.0

(51) Int. Cl. G01D 5/34; B65D 90/48; B65D 88/14; B64D 9/00; G01B 11/14

(52) U.S. Cl. CPC G01D 5/34; B64D 9/003; G01B 11/14; B65D 88/14; B65D 90/48

(57) ABSTRACT

A device and a method for determining the position of a movable transportation unit are described. The device and the method are suitable for accurately detecting the position, automatically fixing loads in position and/or loading and unloading transportation units in aircraft in a relatively quick manner. The device includes a movable transportation unit and a detection means. The transportation unit has a recess for receiving a locking unit in order to lock the transportation unit. The detection means detects when the recess in the movable transportation unit is in a position for engagement with the locking unit. The method for determining the position of a movable transportation unit includes moving the transportation unit from an initial position into a target position, providing the locking unit at the target position of the transportation unit, and locking the locking unit by the engagement thereof in the recess in the transportation unit.

### TECHNICAL FIELD

The invention relates to a device and to a method for determining the position of a movable transportation unit.

### BACKGROUND OF THE INVENTION

There are high requirements in aircraft regarding safeguarding cargo containers and transportation units in aircraft holds. In this regard, it has to be ensured that locking means for the cargo are suitably sturdy so that the cargo does not come loose as a result of flight movements and damage the aircraft structure.

DE 10 2005 061 957 A1 discloses a locking device for fastening cargo load containers for an aircraft. The locking device comprises in this case at least one locking apparatus which has a latching element and can be fitted to the floor of an aircraft.

However, it is furthermore also important that loading and unloading the aircraft, including locking the transportation units, is quick and accurate, so that neither the cargo nor the aircraft are damaged and the aircraft has a quick turnaround.

### BRIEF SUMMARY OF THE INVENTION

Therefore, an aspect of the invention proposes an improved device for determining the position of a movable transportation unit, which facilitates, in particular, quicker loading and unloading of the aircraft, including locking the transportation units.

It is proposed to provide a device for determining the position of a movable transportation unit. The device comprises a movable transportation unit which is an object to be transported. The movable transportation unit can be a vessel, a crate, a container, a box, a transport rack or the like.

In one embodiment, the transportation unit can be moved from an initial position into a target position. The transportation unit can travel on a transportation device, such as on a belt. The transportation unit can also be moved by a pulling and/or pushing device. The transportation unit can be moved, e.g. along an inclination, at least to some extent by gravity.

The transportation unit has a recess for receiving a locking unit. The recess can be made in the transportation unit or can be located on a support or projection of the transportation unit. The recess can be a cavity or a hole. The hole can be a blind hole or a through-hole. The recess can be made in a hollow in the transportation unit, so that the locking unit does not touch the contents of the transportation unit when it is engaged in the recess.

In one embodiment, the position determination device further comprises at least one locking unit of this type, which is used to lock the transportation unit. Locking the transportation unit can include, for example, fixing it in position and/or securing it to prevent shifting. The locking unit is fitted at the target position of the transportation unit. The locking unit can be a bolt, a bar, a thread, a hook, a lug or the like. The locking unit engages in the recess in the transportation unit. The locking unit can be arranged on any side and at any height and width in relation to the transportation unit. The locking unit can be integrated in the wall of the aircraft, for example, such that it does not protrude and cannot be damaged by the transportation unit.

The locking unit can also be a power locking unit (PLU). A PLU is a power bar, i.e. an actuator having very high power for transporting loads of approximately 60 tonnes, for example. A load of this kind would be, for example, two pairs of wings for two Airbus A350 aircraft. Greater loads are also possible. For larger and/or heavier transportation units, it is also possible for a plurality of said PLUs to engage and lock the transportation unit, for example on two sides, in order to prevent shifting. It goes without saying that PLUs having smaller powers can also be used for any relatively small loads.

The locking unit can be electrically or hydraulically operated, for example, and is controlled between the two positions by a control unit. The power required for the movement can be applied by a spring mechanism or a hydraulic system.

The position determination device further comprises a detection means. The detection means detects when the recess in the movable transportation unit is in a position for engagement with the locking unit. The term “in a position for engagement with the locking unit” means that the recess in the movable transportation unit and the locking unit are opposite one another, making it possible for the locking unit to engage in the recess. Engagement of this type would be impossible, for example, if the recess and the locking unit were not aligned, or not fully aligned. The transportation unit and the locking unit can either be touching or almost touching. In one embodiment, the detection means detects when the recess in the movable transportation unit is congruent to the locking unit.

The position determination device is thus able to detect or determine the position of a transportation unit at least when the recess in the transportation unit is in a position for engagement with the locking unit. In this position, the predetermined target position of the transportation unit, the transportation unit can be locked or fixed in position by the locking unit. In other words, the combination of the locking unit as an actuator and the sensor for precise position determination makes it possible to determine the correct point at which the locking unit engages in the recess in the transportation unit.

The position determination device facilitates (semi)automatic, accurate and time-optimised loading and unloading of an aircraft, including locking the transportation units. Semiautomatic is understood as the automatic loading and unloading of an aircraft, including locking, but still with the option of an emergency stop by the user. The position determination device according to the present invention is quicker and more accurate than manually controlled loading processes according to the prior art, requires fewer sensors and components, and is also at least more accurate than automatic loading processes according to the prior art.

In one embodiment, the detection means is at least one sensor for detecting the recess, so that the detection means directly determines when the target position has been reached. The sensor is, for example, an optical sensor having or not having a minor. Other detection means for detecting the recess are also possible, for example magnetic, ultrasonic, capacitive, dielectric or similar detection means. The recess is detected when a physical parameter for example changes compared with the region around the recess. Such a physical parameter can, for example, be electrical conductivity, a magnetic effect, a reflective property or the like. Proxys can also be used and, for example, a specific distance from a reference point can be measured. Combining sensors having the same or different measurement methods is also possible and further increases the accuracy with which the recess is detected. The sensor is preferably either fitted to the locking unit or integrated therein, but can also be fitted so as to be at a distance from the locking unit.

In another embodiment, the transportation unit has at least one mark and the detection means is at least one sensor for detecting such a mark. The mark is arranged for example such that, in relation thereto, the recess can be made congruent to the locking unit. If this is achieved, the transportation unit can be locked at its predetermined target position. The mark and the sensor can function for example magnetically, optically or in the infrared and/or ultrasonic range. The detection means is preferably fitted so as to be at a distance and/or offset from the locking unit, but can also be fitted to the locking unit or integrated therein.

In one embodiment, the position determination device further comprises a tracking unit. The tracking unit is suitable for tracking the position of the movable transportation unit, either continuously or intermittently. The data from the sensor for detecting the mark can be used to monitor and predict the position of the transportation unit and to adjust the speed and/or acceleration of the transportation unit or the transportation device. The speed and/or acceleration of the transportation device can also be used for this purpose. The position determination device can comprise a processor for processing the data and for controlling the transportation unit or transportation device.

The tracking unit can also comprise at least one additional sensor and an algorithm for determining the position of the movable transportation unit. The algorithm forms part of the control unit. The sensor for tracking the transportation unit can determine the position, speed and/or acceleration of the transportation unit. A plurality of sensors can also be used, which, by combining the sensor data, inter alia improves the accuracy of the position determination and/or makes it possible to compensate for a covered sensor.

In one embodiment, the position determination device further comprises a drive unit. The drive unit is suitable for accelerating and/or decelerating the change in position of the movable transportation unit. The drive unit can be continuously controlled so as to prevent unwanted transportation unit speeds. An unwanted speed can be, for example, one which causes the aircraft to oscillate.

The performance, i.e. the time required for the movable transportation unit to be positioned, can be increased by tracking the position of the transportation unit and a local or temporal increase and/or decrease in the speed and/or acceleration. For example, the transportation unit can be accelerated or moved at a high speed up until just before the target position is reached, and cannot be decelerated or moved at a slower speed until just before the target position, allowing for effective manoeuvrability for example.

In one embodiment, the position determination device further comprises a display for showing the position of the movable transportation unit. The display can serve as feedback for the operator regarding the current position and when the target position has been reached.

It is also proposed to provide a method for determining the position of a movable transportation unit. The method comprises the following steps, not necessarily in the given order:
a) providing the movable transportation unit, wherein the transportation unit has a recess for receiving a locking unit in order to lock the transportation unit,
b) providing a detection means, and
c) determining, by the detection means, the position of the transportation unit when the recess in the movable transportation unit is in a position for engagement with the locking unit.

In one embodiment, the method for determining the position of a movable transportation unit further comprises the following steps, not necessarily in the given order:
moving the transportation unit from an initial position into a target position,
providing the locking unit at the target position of the transportation unit, and
locking the locking unit by the engagement thereof in the recess in the transportation unit.

### BRIEF DESCRIPTION OF THE DRAWINGS

Additional features, advantages and possible uses of the present invention are disclosed in the following description of the embodiments and in the figures. In this case, all the features described and/or illustrated form, separately and in any combination, the subject matter of the invention, irrespective of how they are combined in the individual claims or their references. In the figures, the same reference signs denote the same or like components.

FIG. 1 is a 3D view of a device for determining the position of a movable transportation unit.

FIG. 2 is a 3D view of a detail of a movable transportation unit.

FIG. 3 is a schematic representation of a method for determining the position of a movable transportation unit.

### DETAILED DESCRIPTION

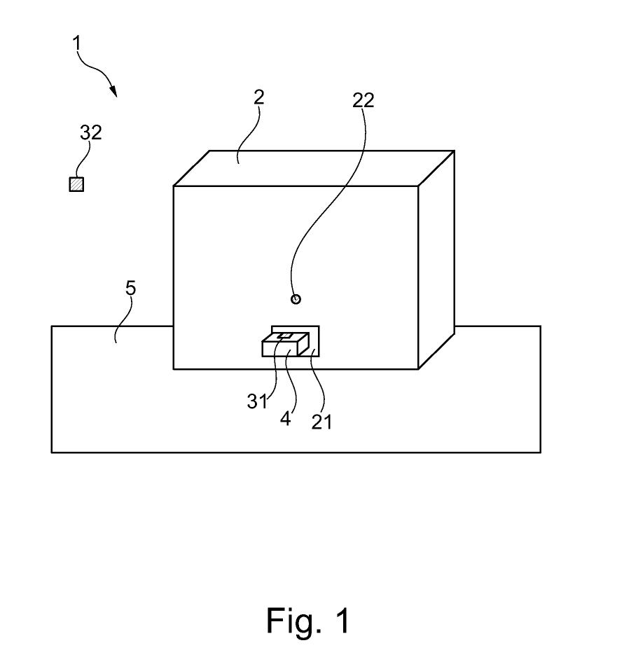

FIG. 1 is a 3D view of a device 1 for determining the position of a movable transportation unit 2. The device comprises a movable transportation unit 2, in this case a container, on a transportation device, in this case a belt. The transportation unit 2 can be moved from an initial position into a target position by means of the transportation device. The target position is shown in FIG. 1.

The transportation unit 2 has a recess 21, in which a locking unit 2 is received. The recess 21 is made in the transportation unit 2, in this case in the form of a hole. The locking unit 4, in this case in the form of a bar, is used to lock the transportation unit 2 and therefore to fix the transportation unit 2 in position, in order to prevent shifting inside the cargo hold of an aircraft, for example. The locking unit 4 is fitted at the target position of the transportation unit 2 and is connected to a cargo hold wall (not shown) of the aircraft, for example. For larger loads, a plurality of locking units engage along the perimeter of the transportation unit in a similar manner, in order to distribute the force during introduction into the aircraft structure. For smaller transportation units, for example two locking units, one on each side of the transportation unit, are sufficient for preventing movement and/or rotation.

The position determination device 1 also comprises a detection means. The detection means detects when the recess 21 in the movable transportation unit 2 is in a position for engagement with the locking unit 4, i.e. in the target position shown in FIG. 1. The term “in a position for engagement with the locking unit 4” means that the recess 21 in the movable transportation unit 2 and the locking unit 4 are opposite one another and the recess 21 in the movable transportation unit 2 is congruent to the locking unit 4. As shown by an arrow in FIG. 1, the locking unit 4 is then able to engage in the recess 21.

In FIG. 1, the detection means is shown as an optical sensor 31 for detecting the recess 21 which is fitted to the locking unit 4. Alternatively or additionally, the transportation unit 2 can also have a mark 22 and the detection means can be a sensor 32 for detecting such a mark 22. The mark 22 is arranged such that, in relation thereto, the recess 21 can be made congruent to the locking unit 4. The mark 22 and the sensor for detecting the mark 22 function, in this case, in the ultrasonic range. The sensor for detecting the mark 22 is fitted so as to be at a distance from the locking unit 4 in this case.

The position determination device 1 further comprises a tracking unit for continuously detecting and tracking the position of the movable transportation unit 2. In the example shown in FIG. 1, the sensor for detecting the mark 22 is also used as the tracking unit. The data from the sensor for detecting the mark 22 are used to monitor and predict the position of the transportation unit 2, and to adjust the speed and/or acceleration of the transportation unit 2 or the transportation device. The speed and/or acceleration of the transportation device is also used in this case for this purpose. For this purpose, the position determination device 1 has a processor (not shown) for processing the data and a control unit (not shown) for controlling the transportation unit 2 or the transportation device.

The tracking unit can however also comprise an additional sensor (not shown) for tracking the transportation unit 2 and an algorithm for determining the position of the movable transportation unit 2. The sensor for tracking the transportation unit 2 can determine the position, speed and/or acceleration of the transportation unit 2. A plurality of sensors can also be used, which, by combining the sensor data, inter alia improves the accuracy of the position determination and/or makes it possible to compensates for a covered sensor.

The position determination device 1 also comprises a controllable drive unit and a display for showing the position of the movable transportation unit 2 (neither of which is shown). The drive unit is suitable for accelerating and/or decelerating the change in position of the movable transportation unit 2. The drive unit can, for example, be shiftable between two speeds and an idle state or can be continuously switchable. The display can serve as feedback for the operator regarding the current position and when the target position has been reached.

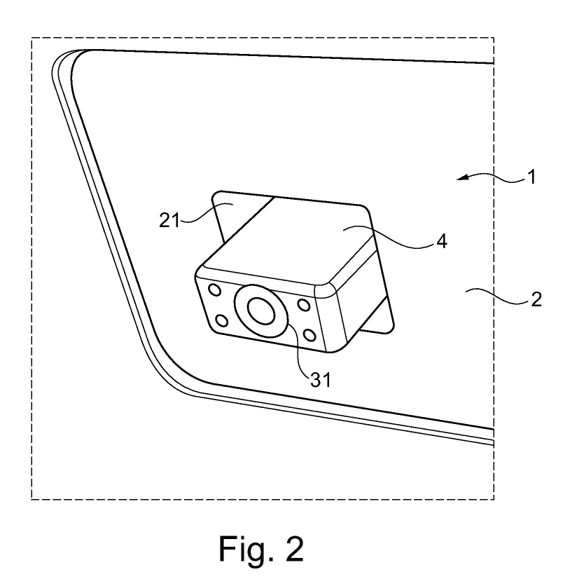

FIG. 2 is a 3D view of a detail of a movable transportation unit 2 showing part of the movable transportation unit 2, the recess 21 therein and the locking unit 4. The locking unit 4 enters the recess 21 in the movable transportation unit 2. The movable transportation unit 2 is, in this case, a box, the recess 21 is, in this case, a hollow in the transportation unit 2 and the locking unit 4 is, in this case, a power locking unit (PLU). The PLU is used to lock the transportation unit 2 and thus to fix and secure the transportation unit 2 in position, to prevent shifting inside the cargo hold of an aircraft, for example. The locking unit 4 is fitted at the target position of the transportation unit 2 and is connected to a cargo hold wall (not shown) of the aircraft, for example.

The locking unit 4 comprises a detection means, in this case a sensor 31 for detecting the recess 21. The sensor 31 for detecting the recess 21 is integrated in the end face of the locking unit 4, in this case in the centre, and thus does not protrude therebeyond. The sensor 31 for detecting the recess 21 detects when the recess 21 in the movable transportation unit 2 is in a position for engagement with the locking unit 4. In this case, the locking unit 4 is introduced into the recess 21 in the transportation unit 2, as shown in FIG. 2.

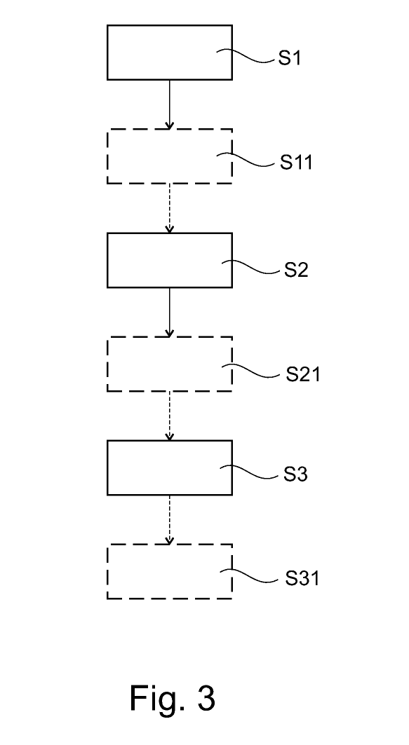

FIG. 3 is a schematic representation of a method for determining the position of a movable transportation unit 2. The method comprises the following steps, not necessarily in the given order:
step S1, providing the movable transportation unit 2, wherein the transportation unit 2 has a recess 21 for receiving a locking unit 4 in order to lock the transportation unit 2,
step S2, providing a detection means, and
step S3, determining, by the detection means, the position of the transportation unit 2 when the recess 21 in the movable transportation unit 2 is in a position for engagement with the locking unit 4.

The method for determining the position of a movable transportation unit 2 can also comprise a step S11 of providing the locking unit 4 at the target position of the transportation unit 2. The method can also comprise a step S21 of moving the transportation unit 2 from an initial position into a target position. The method can also comprise a step S31 of locking the locking unit 4 by the engagement thereof in the recess 21 in the transportation unit 2. Steps S11, S21 and S31 are optional and are therefore only shown in FIG. 3 by a dashed line.

In addition, it should be pointed out that “comprising” does not exclude any other elements or steps and “one” does not exclude a plurality. Furthermore, it should be pointed out that features or steps which have been described with reference to one of the above embodiments, can also be used in combination with other features or steps of other above-described embodiments. Reference signs in the claims should not be considered as a limitation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for determining the position of a movable transportation unit, comprising:
a movable transportation unit; and
a detection means,
wherein the transportation unit has a recess for receiving a locking unit to lock the transportation unit, and
wherein the detection means is configured to detect when the recess in the movable transportation unit is in a position for engagement with the locking unit.

2. The device according to claim 1, wherein the transportation unit is configured to be moved from an initial position into a target position, and
wherein the position determination device further comprises the locking unit for locking the transportation unit, and
wherein the locking unit is fitted at the target position of the transportation unit.

3. The device according to claim 1, wherein the detection means is configured to detect when the recess in the movable transportation unit is congruent to the locking unit.

4. The device according to claim 1, wherein the detection means is a sensor for detecting the recess and is either fitted to the locking unit or integrated therein.

5. The device according to claim 4, wherein the sensor for detecting the recess is configured to detect the recess by at least one of: measuring varying physical parameters between the recess and a region around the recess and measuring a distance from a reference point.

6. The device according to claim 1, wherein the transportation unit has a mark, the detection means is a sensor for detecting such a mark and the detection means is fitted so as to be at a distance from the locking unit.

7. The device according to claim 6, wherein the mark is magnetic and functions within the optical, infrared and/or ultrasonic range.

8. The device according to claim 1, further comprising a tracking unit suitable for tracking the position of the movable transportation unit, and
a drive unit suitable for accelerating and/or decelerating the change in position of the movable transportation unit.

9. A method for determining the position of a movable transportation unit, comprising:
providing the movable transportation unit;
wherein the transportation unit has a recess for receiving a locking unit to lock the transportation unit,
providing a detection means; and
determining, by the detection means, the position of the transportation unit when the recess in the movable transportation unit is in a position for engagement with the locking unit.

10. The method according to claim 9, wherein the method further comprises:
moving the transportation unit from an initial position into a target position;
providing the locking unit at the target position of the transportation unit; and
locking the locking unit by the engagement thereof in the recess in the transportation unit.
